(19) United States
(12) Patent Application Publication
(10) Pub. No.: US 2007/0076550 A1
(43) Pub. Date: Apr. 5, 2007

(54) Optical disk device and optimal recording power determination method

(75) Inventors: Tatsuro Shimizu, Yokohama-shi (JP); Manabu Nomoto, Hachioji-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Samsung Storage Technology Corporation, Kawasaki-City (JP)

(21) Appl. No.: 11/527,620

(22) Filed: Sep. 27, 2006

(30) Foreign Application Priority Data
Sep. 30, 2005 (JP) 2005-288698

(51) Int. Cl. G11B 7/12

(52) U.S. Cl. 369/47.51

(57) ABSTRACT

An optical disk device includes a format determination unit which determines a format causing an intersymbol interference ratio of not less than a preset value, as a format for power calibration performed on an optical disk, when an intersymbol interference ratio of data to be recorded on the optical disk is lower than a preset value, a power calibration unit which executes power calibration on the optical disk using the format determined by the format determination unit, an optimal power determination unit which determines optimal power for a laser beam used to record the data, based on a result of the power calibration by the power calibration unit, and a recording unit which records the data on the optical disk using a laser beam corresponding to the optimal power determined by the optimal power determination unit.

### CROSS-REFERENCE TO RELATED APPLICATIONS

This application is based upon and claims the benefit of priority from prior Japanese Patent Application No. 2005-288698, filed Sep. 30, 2005, the entire contents of which are incorporated herein by reference.

### BACKGROUND OF THE INVENTION

1. Field of the Invention

The present invention relates to an optical disk device in which optical laser power is determined by test writing performed for power calibration on a recordable or rewritable optical disk, and optical recording power determination method for use in the device.

2. Description of the Related Art

In optical disk devices, when data is recorded on a recordable or rewritable optical disk, optimal recording power with which a laser beam is emitted is determined before starting recording of data, in light of variations in the characteristics of optical disks or laser diodes.

The determination of optical laser power is executed by performing, before recording actual data, power calibration on a power calibration area (PCA) provided on an optical disk, while gradually varying recording power.

There is a conventional method for controlling recording laser power to acquire an optimal recording laser power level, in which a signal of a low frequency and a signal of a high frequency are alternately recorded while recording power is varied (see, for example, Jpn. Pat. Appln. KOKAI Publication No. 2003-346341).

More specifically, in the recording laser power control method disclosed in Jpn. Pat. Appln. KOKAI Publication No. 2003-346341, the signals of low and high frequencies are divided into components in units of preset periods, and the resultant signals are recorded with different recording power levels. Further, the signals recorded on the optical disk are reproduced, and the respective middle levels of the amplitudes of the pulses of the reproduced signals corresponding to the low-frequency and high-frequency signals, acquired in units of preset periods, are compared to determine recording laser power actually used.

### BRIEF SUMMARY OF THE INVENTION

In accordance with an aspect of the invention, there is provided an optical disk device comprising: a format determination unit which determines a format causing an intersymbol interference ratio of not less than a preset value, as a format for power calibration performed on an optical disk, when an intersymbol interference ratio of data to be recorded on the optical disk is lower than a preset value; a power calibration unit which executes power calibration on the optical disk using the format determined by the format determination unit; an optimal power determination unit which determines optimal power for a laser beam used to record the data, based on a result of the power calibration by the power calibration unit; and a recording unit which records the data on the optical disk using a laser beam corresponding to the optimal power determined by the optimal power determination unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating the configuration of an optical disk device according to an embodiment of the invention;

FIG. 2 is a graph useful in explaining the intersymbol interference ratio used for indicating the degree of the intersymbol interference of data recorded on an optical disk 10 employed in the embodiment;

FIG. 3 is a flowchart useful in explaining the operation of recording data on the optical disk 10 in the embodiment;

FIG. 4 is a flowchart useful in explaining a recording format determination routine based on the intersymbol interference ratio and employed in the embodiment; and

FIGS. 5A to 5F are views illustrating various signals used in the embodiment for determining optimal recording power.

### DETAILED DESCRIPTION OF THE INVENTION

An embodiment of the invention will be described with reference to the accompanying drawings.

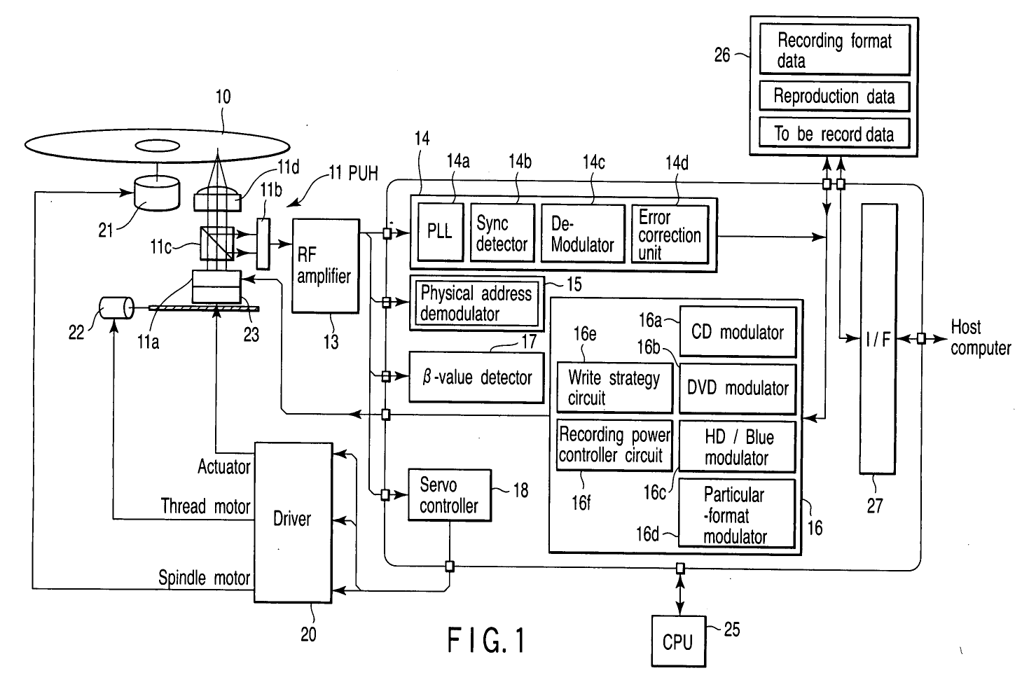

FIG. 1 is a block diagram illustrating the configuration of an optical disk device according to an embodiment of the invention.

An optical disk 10 as a recording medium has a spiral track formed on its surface, and is rotated by a spindle motor 21. In the optical disk device of the embodiment, it is assumed that three types of disks, such as a compact disk (CD), digital versatile disk (DVD) and high definition DVD (HD-DVD), are usable as the optical disk 10.

Recording and reproduction of information on and from the optical disk 10 is performed using a laser beam output from an optical pickup head (PUH) 11.

The optical pickup head 11 includes laser diodes 11a, collimator lens 11c, beam splitter, object lens 11d, cylindrical lens, photodetector 11b, and lens position sensor, etc.

The optical disk device of the embodiment employs a plurality of laser diodes 11a that output, under the control of the laser controller 16, laser beams of different wavelengths. Actually, in accordance with the type of the optical disk 10 (i.e., CD, DVD or HD-DVD), a laser beam is output from the corresponding one of the laser diodes 11a. The laser diodes 11a include an infrared laser (wavelength: 780 nm) for CDs, a red laser (wavelength: 650 nm) for DVDs, and a blue laser (wavelength: 405 nm) for HD-DVDs.

The laser beam output from each laser diode 11a is emitted onto the optical disk 10 via the collimator lens 11c, beam splitter and object lens 11d. The light reflected from the optical disk 10 is guided to the photodetector 11b via the object lens 11d, beam splitter and cylindrical lens. The photodetector 11b is formed of, for example, 4 photodetector cells, and outputs the detection signals of the photodetector cells to an RF amplifier 13. The photodetector 11b includes photodiodes corresponding to the infrared laser for CDs, red laser for DVDs, and blue laser for HD-DVDs.

The RF amplifier 13 processes a signal from the photodetector 11b, and outputs the processing result. Specifically, the RF amplifier 13 generates and outputs a tracking error signal indicating deviation of the center of the beam spot of a laser beam from the center of the track, a focus error signal indicating deviation of a laser beam from a just focused point, and a total signal (RF signal) acquired by adding the signals output from the four photodetector cells of the photodetector 11b.

The total signal (RF signal) generated by the RF amplifier 13 is sent to a data reproduction unit 14, physical address demodulator 15 and β-value detector 17.

The data reproduction unit 14 performs data reproduction processing based on an RF signal from the RF amplifier 13, and includes a PLL circuit 14a, Sync detection circuit 14b, demodulator 14c and error correction circuit 14d, etc.

In the data reproduction unit 14, the PLL circuit 14a generates a bit synchronous clock based on the RF signal, the Sync detection circuit 14b detects a Sync signal based on the bit synchronous clock supplied from the PLL circuit 14a. The demodulator 14c demodulates data into 8-bit data, using 8/16 modulation scheme, in synchronism with the Sync signal detected by the Sync detection circuit 14b. The error correction circuit 14d performs error correction on the data demodulated by the demodulator 14c. The reproduction data output from the data reproduction unit 14 is temporarily stored in a memory 26, and output to a host computer via an interface circuit 27.

The physical address demodulator 15 detects address data based on the RF signal supplied from the RF amplifier 13, using, for example, the land pre-pit (LPP) scheme (for DVD−R) that utilizes pits formed in a land region on the optical disk 10, or using the address in pre-groove (ADIP) scheme (for DVD+R) that utilizes a wobbled groove formed in the optical disk 10. In accordance with the address detected by the physical address demodulator 15, data is recorded on the optical disk 10.

The RF signal output from the RF amplifier 13 is input to a β-value detector 17. The β-value detector 17 detects the top peak value A and bottom peak value B of the RF signal, and detects an asymmetry value β based on the detected peak values and using the following equation:
β=(A+B)/(A−B)

Using the asymmetry value β detected by the β-value detector 17, optimal recording power for data recording is determined.

On the other hand, the tracking error signal and focus error signal output from the RF amplifier 13 are sent to a servo controller 18.

In accordance with the focus error signal from the RF amplifier 13, the servo controller 18 causes a driver 20 to drive an actuator (focusing actuator) 23, thereby performing servo focusing so that the laser beam output from the optical pickup head 11 will be just focused on the recording film of the optical disk 10.

Further, in accordance with the tracking error signal from the RF amplifier 13, the servo controller 18 causes the driver 20 to drive an actuator (tracking actuator) 23 and/or a thread motor 22, thereby performing servo tracking so that the laser beam output from the object lens 11d will always trace the track formed on the optical disk 10.

The driver 20 drives, under the control of the servo controller 18, the spindle motor 21 for rotating the optical disk 10, the thread motor 22 for moving the optical pickup head 11 radially (i.e., in the direction of tracking), and the actuator 23 for moving the object lens 11d of the optical pickup head 11 in the focusing direction (i.e., the direction of the optical axis of the lens), and in the tracking direction (i.e., the radial direction of the optical disk 10).

The laser controller 16 controls the laser diodes 11a during reproduction and recording of data. The laser controller 16 comprises a CD modulator 16a for CDs, a DVD modulator 16b for DVDs and a HD/Blue modulator 16c for HD-DVDs, which modulate to-be-recorded data into a format corresponding to the optical disk 10 during recording, and a particular-format modulator 16d for particular formats. The laser controller 16 controls the laser radiation period (pulse width) during data writing, using a write strategy circuit 16e, and controls the recording power of a laser beam, using a recording power control circuit 16f.

In the embodiment, before writing data to the optical disk 10, optimal recording power is determined by performing power calibration on a power calibration area (PCA) provided on the optical disk 10.

A CPU 25 controls the entire device using the memory (RAM area) 26 as a working area. More specifically, the CPU 25 controls each section in accordance with an operation command sent from the host computer via the interface circuit 27, using the program stored in the memory (ROM area) 26. The optical disk device of the embodiment determines optimal recording power with which data is recorded to the optical disk 10 mounted, by performing power calibration in the power calibration area (PCA) provided on the optical disk 10. At this time, if the CPU 25 determines that when test writing for power calibration is performed on the optical disk 10, great intersymbol interference occurs during the reproduction of the written data, it performs power calibration using a format that causes less intersymbol interference.

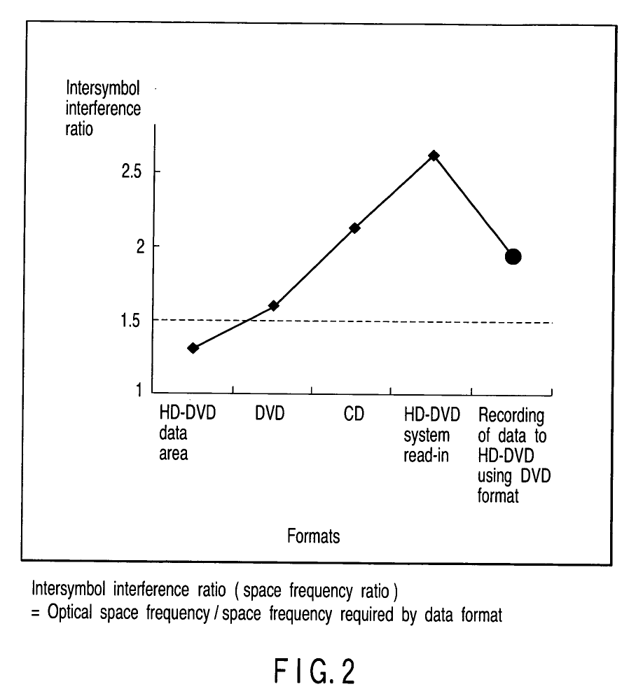

FIG. 2 is a graph useful in explaining the intersymbol interference ratio used for indicating the degree of the intersymbol interference of data recorded on the optical disk 10. FIG. 2 indicates, from the leftmost point of the abscissa (indicating formats), the intersymbol interference ratio acquired when recording is performed using a standard format (recording/reproduction using a blue laser beam) for an HD-DVD data region, the intersymbol interference ratio acquired when recording is performed using a CD format (recording/reproduction using an infrared laser beam), the intersymbol interference ratio acquired when recording is performed using an HD-DVD system read-in format (reproduction using a blue laser beam), and the intersymbol interference ratio acquired when recording is performed on an HD-DVD data region, using a DVD format (recording/reproduction using a blue laser beam). The intersymbol interference ratio is computed based on the optical-system space frequency determined from the wavelength of a laser beam emitted by the object lens 11d, and the space frequency required by the data format of the optical disk 10, using the following equation:
Intersymbol interference ratio (space frequency ratio)=(2NA/λ)/(1/(2*Tmin))

where 2NA/λ represents an optical-system space frequency, 1/(2*Tmin) represents the space frequency required by a data format, NA is the aperture of an optical system, λ is the wavelength [nm] of a laser beam, and Tmin is a minimum mark length [μm].

The higher the intersymbol interference ratio, the lower the degree of intersymbol interference.

In general, in power calibration performed to determine optimal recording power before executing data writing, the format corresponding to the type of the optical disk, to which data is written, is used. For instance, in the case of a DVD for which a red laser beam is used, a DVD format (that conforms to the DVD standards) modulated by the DVD modulator 16b is used. Similarly, in the case of a CD, a CD format (that conforms to the CD standards) modulated by the CD modulator 16a is used. There is also a case where a preset repetition pattern (e.g., the 3T/11T format) is used.

In the embodiment, when data that causes high-degree intersymbol interference corresponding to a space frequency ratio of less than 1.5 is written, i.e., when calibration data is written to the power calibration area (part of the data area) of an HD-DVD using a blue laser beam, power calibration is performed using a format of low-degree intersymbol interference (e.g., a DVD format with a minimum mark of 3T), instead of using an HD-DVD format (with a minimum mark is 2T) modulated by the HD/Blue modulator 16c. As a result, intersymbol interference can be eliminated when written data is reproduced, thereby enabling optimal recording power to be determined accurately.

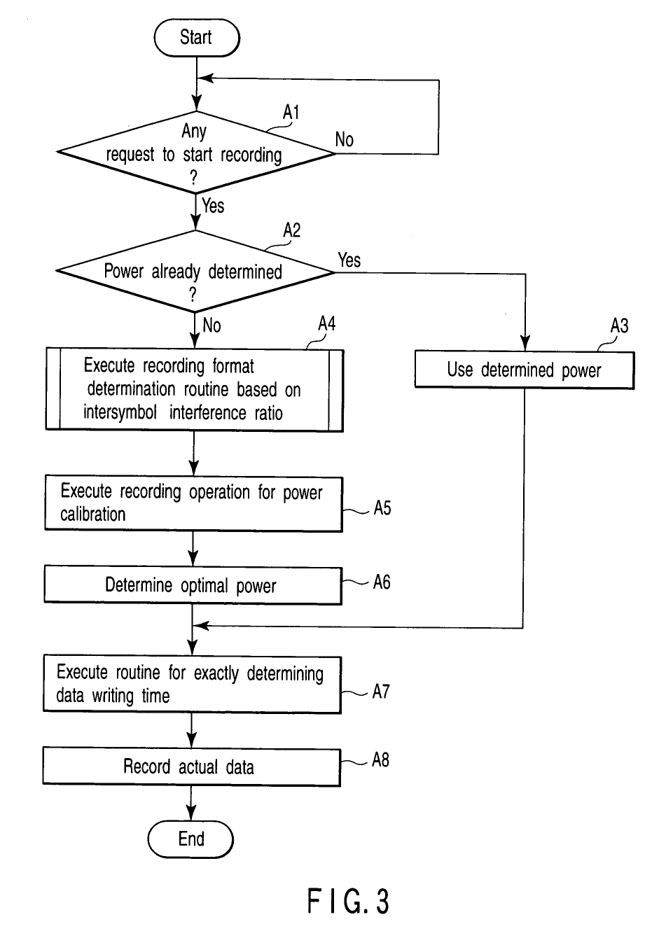

Referring to the flowchart of FIG. 3, the operation of the optical disk device according to the embodiment will be described.

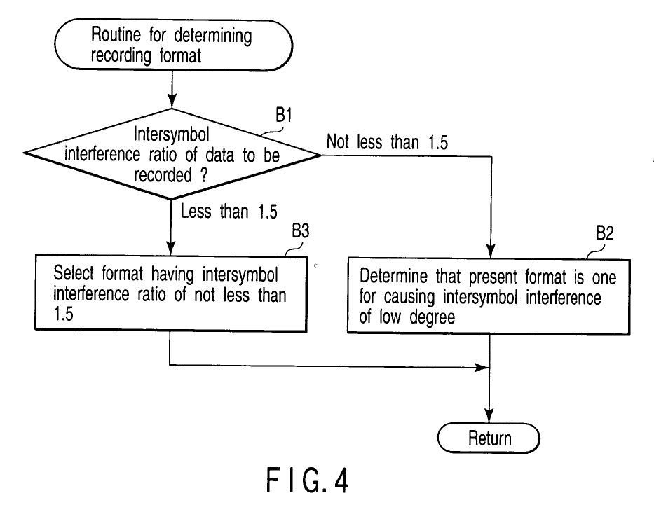

FIG. 3 is a flowchart useful in explaining the operation of recording data on the optical disk 10. FIG. 4 is a flowchart useful in explaining a recording format determination routine based on the intersymbol interference ratio and used in the power calibration area.

Firstly, upon receiving a request to start recording of data from the host computer via the interface circuit 27 (Yes at step A1), the CPU 25 determines whether the power of a laser beam for recording data on the optical disk 10 is set.

If the recording power is not yet set (No at step A2), the CPU 25 executes a recording format determination routine based on the intersymbol interference ratio (step A4).

As shown in FIG. 4, in the recording format determination routine based on the intersymbol interference ratio, it is determined whether the present data writing condition is a condition in which the intersymbol interference ratio of the calibration data to be recorded is less than 1.5 (step B1).

Specifically, when the optical disk 10 mounted in the optical disk device is an HD-DVD for recording data using a blue laser beam, and data is written to the power calibration area of the HD-DVD, as shown in FIG. 2, the CPU 25 determines that the intersymbol interference ratio is less than 1.5 if a standard HD-DVD format is used.

If it is determined that the intersymbol interference ratio is less than 1.5 (i.e., the answer to step B1 is less than 1.5), the CPU 25 selects a format that enables the intersymbol interference ratio to be set to not less than 1.5 (step B3). For instance, a DVD format or CD format is selected. Further, if a format of a preset repetition pattern, e.g., the 3T/11T format, is used, the 5T(or 4T)/11T format is selected instead.

In contrast, if the present data writing condition is a condition in which the intersymbol interference ratio of the calibration data to be recorded is not less than 1.5 (i.e., the answer to step B1 is not less than 1.5), the CPU 25 selects a format corresponds to the type of the optical disk 10 (this is equivalent to the case where a format that causes a low degree of intersymbol interference is selected). Alternatively, a format that causes a lower degree of intersymbol interference may be selected (step B2).

For instance, if the mounted optical disk 10 is a DVD or CD, the CPU 25 selects a DVD format or CD format. Further, a format of a preset repetition pattern, such as the 3T/1T format, is selected.

After a calibration format that causes a low degree of intersymbol interference is selected, a calibration operation is executed using the format (step A5).

Specifically, firstly, the CPU 25 controls the servo controller 18 to perform the seeking operation to move the object lens 11d to the power calibration position in the power calibration area (PCA) of the optical disk 10. Further, the laser controller 16 sets an initial laser power value (recording laser power value) for the laser diodes 11a, and controls recording while varying recording power in units of preset periods in accordance with the address (synchronization signal) detected by the physical address demodulator 15.

After preset writing is finished, power calibration is finished, and the CPU 25 read the written data. Specifically, the rotational speed of the spindle motor 21 is set to a reproduction rotational speed supplied from the CPU 25, and the actuator 23 and thread motor 22 are driven to seek the optical beam of the optical pickup head 11 to the position at which power calibration was performed, whereby the data is read from the power calibration area.

Based on an RF signal output from the RF amplifier 13 after reading the written data, the β-value detection circuit 17 detects an asymmetry value (β). Based on the asymmetry value (β) detected by the β-value detection circuit 17, the CPU 25 determines optimal recording power (step A6).

In contrast, if it is determined at step A2 that the recording power is already set, the set recording power is used (step A7, A8).

When the recording power for data recording is determined (step A6, A3), the CPU 25 writes a written data in the optical disk 10 using the recording power. Specifically, the time of data writing is exactly adjusted based on the address detected by the physical address demodulator 15 (step A7), and to-be-written data stored in the memory 26 is modulated into a recording pulse signal by one of the modulators 16a to 16d that corresponds to the type of the optical disk 10. In accordance with the pulse signal, the to-be-written data is written to the data area under the control of the write strategy circuit 16e and recording power control circuit 16f.

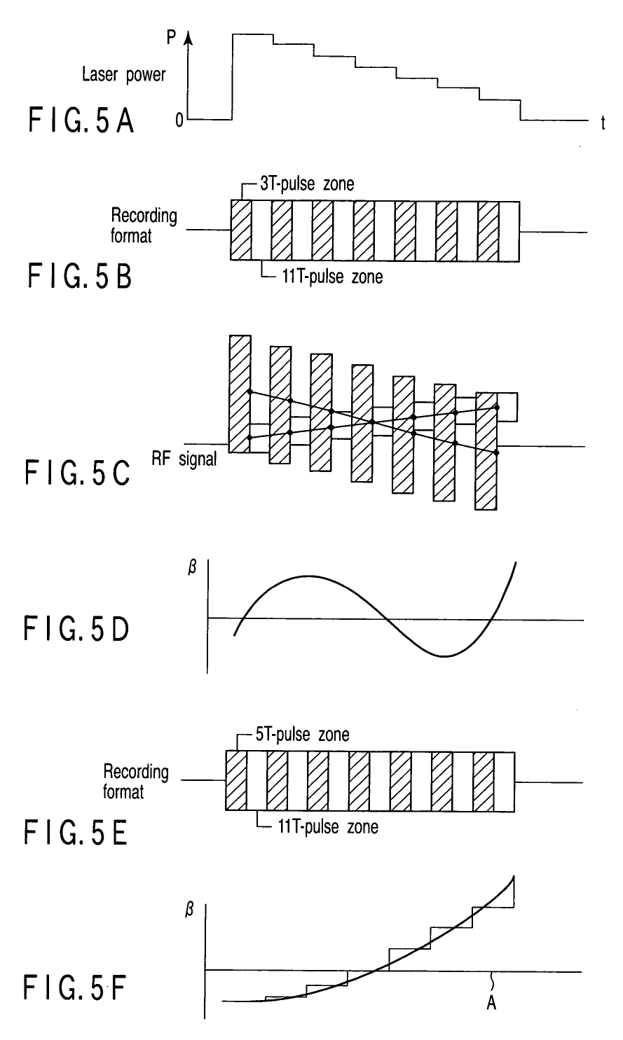

FIGS. 5A to 5F show signals used to determine the optimal recording power.

FIG. 5A shows variations in the power of a laser beam emitted for power calibration from each laser diode 11a to the power calibration area (PCA). As can be understood from FIG. 5A, the power is varied stepwise in units of preset periods. Although in the case of FIG. 5A, the recording power is gradually reduced, it may be gradually increased.

FIG. 5B shows recording signals recorded in respective stages of the recording power. For instance, when the degree of intersymbol interference is low (i.e., the intersymbol interference ratio is not less than 1.5), the 3T/11T format, in which a 11T pulse zone and 3T pulse zone are repeated as shown in FIG. 5B, is used.

In this case, since there is no intersymbol interference, the RF signal (reproduction signal) as shown in FIG. 5C is acquired when data recorded using the format is read. As shown in FIG. 5C, the reproduction signal varies in level in accordance with changes in recording power, and has different amplitudes between the 11T pulse zone and 3T pulse zone. FIG. 5F shows, in the form of an asymmetry waveform, changes in asymmetry values detected based on reproduction signal levels acquired at different recording power levels when no intersymbol interference exists. As shown in FIG. 5F, the asymmetry values detected based on reproduction signal levels acquired at different recording power levels vary substantially linearly. In this signal, the recording laser power acquired when the middle value of the amplitude of the 11T-pulse zone is substantially equal to that of the amplitude of the 3T-pulse zone, i.e., the asymmetry values of the 11-pulse zone and 3T-pulse zone are substantially equal to each other, can be determined as optimal recording laser power. (Namely, the recording power corresponding to the position at which the asymmetry waveform intersects the level A indicating 50% of the average of all amplitude levels (voltages) can be determined as the optimal recording laser power as shown in FIG. 5F.) In contrast, if the degree of intersymbol interference is high (if the intersymbol interference ratio is less than 1.5), and the 3T/11T format shown in FIG. 5B is used, the asymmetry waveform as shown in FIG. 5D is acquired because of intersymbol interference, and optimal recording power may not be determined. Namely, two or more recording power levels may be acquired when the middle value of the amplitude of the 11T-pulse zone is substantially equal to that of the amplitude of the 3T-pulse zone.

In the embodiment, when the degree of intersymbol interference is high, the 5T/11T format shown in FIG. 5E, for example, which causes less intersymbol interference, is used, thereby acquiring a reproduction signal having the asymmetry waveform as shown in FIG. 5F. As a result, optimal recording power can be determined.

As described above, when the degree of intersymbol interference is high (the intersymbol interference ratio is less than 1.5) during writing of calibration data on the optical disk 10, if the format that causes an intersymbol interference ratio of not less than 1.5 is selected, intersymbol interference can be eliminated and optimal recording power can be determined.

The above-described embodiment includes various inventions, and various inventions can be extracted by appropriately combining the structure elements disclosed in the embodiment. For instance, even if some of the disclosed structural elements are deleted, the resultant structure can be extracted as an invention if it can achieve the object of the invention and provide the same advantage as the above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk device comprising:
a format determination unit which determines a format causing an intersymbol interference ratio of not less than a preset value, as a format for power calibration performed on an optical disk, when an intersymbol interference ratio of data to be recorded on the optical disk is lower than a preset value;
a power calibration unit which executes power calibration on the optical disk using the format determined by the format determination unit;
an optimal power determination unit which determines optimal power for a laser beam used to record the data, based on a result of the power calibration by the power calibration unit; and
a recording unit which records the data on the optical disk using a laser beam corresponding to the optimal power determined by the optimal power determination unit.

2. The optical disk device according to claim 1, wherein the intersymbol interference ratio is given by
(2NA/λ)/(1/(2*Tmin))
where 2NA/λ represents an optical-system space frequency, 1/(2*Tmin) represents a space frequency required by a data format, NA is an aperture, λ is a laser wavelength [nm], and Tmin is a minimum mark length [μm], the format determination unit determining a format causing an intersymbol interference ratio of not less than 1.5, as the format for the power calibration, when the intersymbol interference ratio of data to be recorded on the optical disk is lower than 1.5.

3. The optical disk device according to claim 1, wherein the format determination unit determines the format causing the intersymbol interference ratio of not less than the preset value, as the format for the power calibration, when data is written to the optical disk using a blue laser beam.

4. An optimal recording power determination method for use in an optical disk device for recoding data to an optical disk using a laser beam, comprising:
determining a format causing an intersymbol interference ratio of not less than a preset value, as a format for power calibration performed on the optical disk, when an intersymbol interference ratio of data to be recorded on the optical disk is lower than a preset value;
executing power calibration on the optical disk using the determined format;
determining optimal power for a laser beam used to record the data, based on a result of the power calibration.
